(19) United States
(12) Patent Application Publication
(10) Pub. No.: US 2012/0171536 A1
(43) Pub. Date: Jul. 5, 2012

(54) NON-AQUEOUS SECONDARY BATTERY AND ELECTRODE ASSEMBLY USED THEREFOR

(76) Inventor: Mayumi Kaneda, Osaka (JP)

(21) Appl. No.: 13/258,278

(22) PCT Filed: Apr. 27, 2010
(86) PCT No.: PCT/JP2010/003011

§ 371 Date: Sep. 21, 2011

(51) Int. Cl. H01M 2/16; H01M 10/0565; H01M 4/64; H01M 4/70

(52) U.S. Cl. 429/94; 429/142; 429/129

(57) ABSTRACT

A non-aqueous secondary battery including: a positive electrode plate including a positive electrode current collector in long strip form, and a positive electrode active material layer adhering to the surface of the positive electrode current collector; a negative electrode plate including a negative electrode current collector in long strip form, and a negative electrode active material layer adhering to the surface of the negative electrode current collector; a porous insulating layer interposed between the positive electrode plate and the negative electrode plate; a non-aqueous electrolyte; and a spacer in film form disposed at least between the positive electrode plate and the porous insulating layer or between the negative electrode plate and the porous insulating layer, the spacer being constituted of a resin dissolvable in the non-aqueous electrolyte.

### RELATED APPLICATIONS

This application is the U.S. National Phase under 35 U.S.C. §371 of International Application No. PCT/JP2010/003011, filed on Apr. 27, 2010, the disclosure of which is incorporated by reference herein.

### TECHNICAL FIELD

The present invention relates to a non-aqueous secondary battery represented by lithium ion batteries, and an electrode assembly used therefor.

### BACKGROUND ART

In recent years, non-aqueous secondary batteries represented by lithium ion batteries are utilized as the power source for portable electronic devices. A non-aqueous secondary battery uses as the negative electrode active material, a carbonaceous material capable of absorbing and releasing lithium, and as the positive electrode active material, a composite oxide of a transition metal and lithium, such as LiCoO₂. Due to these active materials, non-aqueous secondary batteries with high potential and high discharge capacity have been realized. However, further size reduction and higher capacity are demanded of non-aqueous secondary batteries, in accordance with increased functions and size reduction in electronic devices and communications devices.

To realize non-aqueous secondary batteries with higher capacity, employed as the positive and negative electrode plates is an electrode plate which is a current collector in long strip form, having material mixture layers (active material layers) containing an active material formed on the surfaces thereof. For the electrode plate, capacity can be increased by filling the electrode plate densely with an active material, by pressing or the like. The positive and negative electrode plates are spirally wound with a separator interposed therebetween, thereby forming an electrode assembly. The electrode assembly is housed together with a non-aqueous electrolyte, inside a battery case made of metal such as stainless steel.

Although higher capacity is being realized, there are instances where battery temperature rises rapidly due to causes such as internal short circuits and becomes uncontrollable. Therefore, high level of safety is required of non-aqueous secondary batteries. Particularly, in non-aqueous secondary batteries relatively larger in size and higher in capacity, there is a higher risk of thermal runaway occurring.

Internal short circuits are believed to occur, for example, due to causes such as breakage and buckling of the electrode plate, in addition to extraneous substances intruding into the battery. Breakage and buckling of the electrode plate occur due to the electrode plate being stressed during formation of the electrode assembly as well as during charge and discharge of the battery.

Among battery assemblies, there are those fabricated by spirally winding the electrode plates together with the separator, and then compression molding the resultant in a direction perpendicular to the winding axis, for it to be flat. With the winding and the compression molding, the electrode plates and the separator fabricating the electrode assembly become severely stressed, at parts where the radius of curvature is small. At the parts where stressed, there is separation of the active material layer, as well as breakage of the member with the smallest elongation ability, resulting from the difference in elongation ability among the electrode plates and the separator.

When a non-aqueous secondary battery is charged, with the intercalation of lithium into the negative electrode plate, the negative electrode plate expands and its volume increases. Particularly, repeated charge and discharge cause stress to the electrode plate due to repeated expansion and contraction, and the electrode assembly buckles, thereby causing its shape to deform. There are instances where the deformed electrode assembly presses against the battery case from the inside, and at times, the battery case expands. When deformation of the electrode assembly progresses, the member with the smallest elongation ability preferentially breaks, like the above.

In the case where the positive or negative electrode plate breaks before the separator, the broken portion of either of the electrode plates may penetrate through the separator, thereby causing the positive and negative electrode plates to short circuit. There is a possibility of a large current flowing due to this short circuit, leading to a rapid rise in the temperature of the non-aqueous secondary battery, and further leading to a thermal runaway in the non-aqueous secondary battery as described above.

To suppress buckling, proposals have been made for a method to create a gap between the electrodes, by a looser winding. As shown in FIG. 8, in PTL 1 for example, a proposal is made for an electrode assembly 91 to be held between belts 92 each stretched between rotational rollers, and then to be rotated while being pressed in a direction perpendicular to the winding axis.

Further, as shown in FIG. 9, PTL 2 proposes a method in which metallic lithium P1 and metallic lithium P2 are laminated on both surfaces of a negative electrode plate A, respectively, when stacking and then winding a positive electrode plate C, a separator S1, the negative electrode plate A, and a separator S2.

### CITATION LIST

### Patent Literatures

PTL [1] Japanese Laid-Open Patent Publication No. 2006-164956
PTL [2] Japanese Laid-Open Patent Publication No. 2008-016193

### SUMMARY OF INVENTION

### Technical Problem

However, in PTL 1, although the effect of suppressing buckling is produced by the creation of the gap, it is difficult to always loosen an electrode assembly with regularity, once it is wound. Moreover, rotating the electrode assembly in a pressed and thus deformed state may cause the active material layer to separate from the electrode plate, and the current collectors thus exposed to come in contact with each other. Further, the active material layer that has separated may penetrate through the separator and cause the positive and negative electrode plates to short circuit.

In PTL 2, dissolution of metallic lithium disposed between the separator and the negative electrode plate causes lithium to be in excess, thereby causing formation of lithium dendrites. If the lithium dendrites penetrate through the separator, the positive and negative electrode plates would short circuit.

The present invention provides a non-aqueous secondary battery with high level of safety, which enables effective suppression of internal short circuits caused by breakage, buckling, etc. of the electrode plate in instances where it expands and contracts, and also provides an electrode assembly used therefor.

### Solution to Problem

One aspect of the present invention relates to a non-aqueous secondary battery comprising: a positive electrode plate including a positive electrode current collector in long strip form, and a positive electrode active material layer adhering to the surface of the positive electrode current collector; a negative electrode plate including a negative electrode current collector in long strip form, and a negative electrode active material layer adhering to the surface of the negative electrode current collector; a porous insulating layer interposed between the positive electrode plate and the negative electrode plate; a non-aqueous electrolyte; and a spacer in film form disposed at least between the positive electrode plate and the porous insulating layer or between the negative electrode plate and the porous insulating layer, the spacer comprising a resin dissolvable in the non-aqueous electrolyte.

Another aspect of the present invention relates to an electrode assembly for a non-aqueous secondary battery comprising: a positive electrode plate including a positive electrode current collector in long strip form, and a positive electrode active material layer adhering to the surface of the positive electrode current collector; a negative electrode plate including a negative electrode current collector in long strip form, and a negative electrode active material layer adhering to the surface of the negative electrode current collector; a porous insulating layer interposed between the positive electrode plate and the negative electrode plate; and a spacer in film form interposed at least between the positive electrode plate and the porous insulating layer or between the negative electrode plate and the porous insulating layer, the spacer comprising a resin having a solubility such that at 25° C., 3 g or more thereof dissolve in 100 g of a mixed solvent in which the weight ratio of ethylene carbonate, ethyl methyl carbonate, and diethyl carbonate is 20:30:50.

While the novel features of the invention are set forth particularly in the appended claims, the invention, both as to organization and content, will be better understood and appreciated, along with other objects and features thereof, from the following detailed description taken in conjunction with the drawings.

### Advantageous Effects of Invention

In the present invention, a spacer comprising a resin dissolvable in a non-aqueous electrolyte is disposed at least between a positive electrode plate and a porous insulating layer or between a negative electrode plate and the porous insulating layer, and therefore, a gap is created due to the dissolving of the spacer. Thus, even if the electrode plate expands and contracts, internal short circuits caused by breakage, buckling, etc. are suppressed, thereby enabling higher level of safety in non-aqueous secondary batteries.

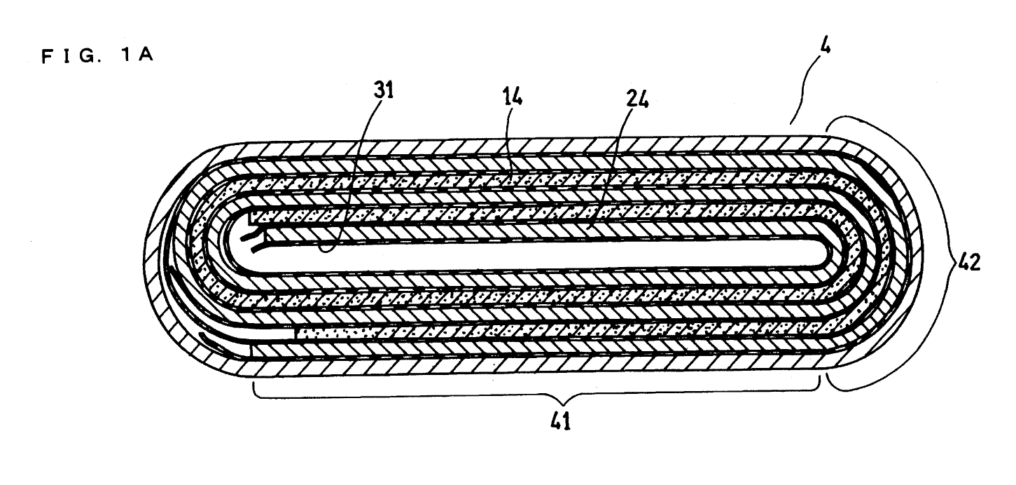

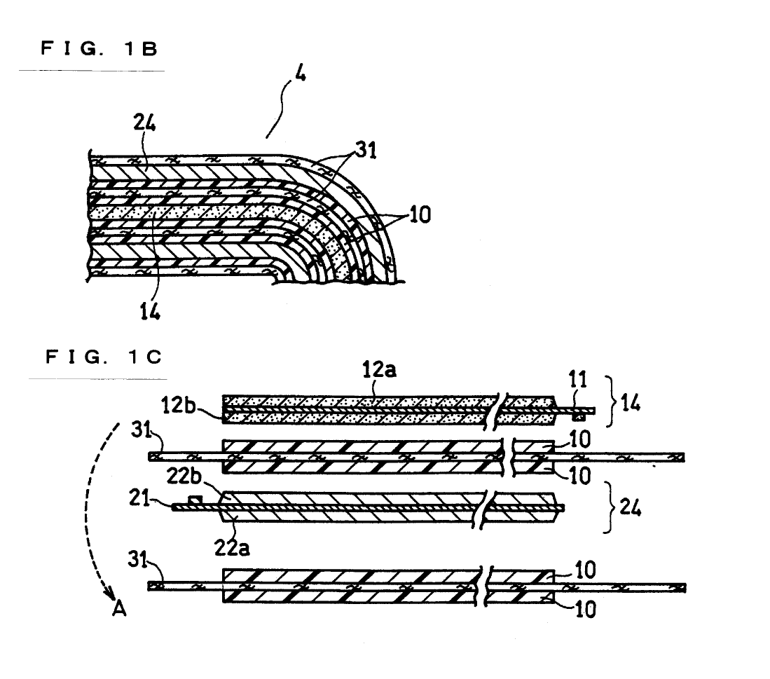

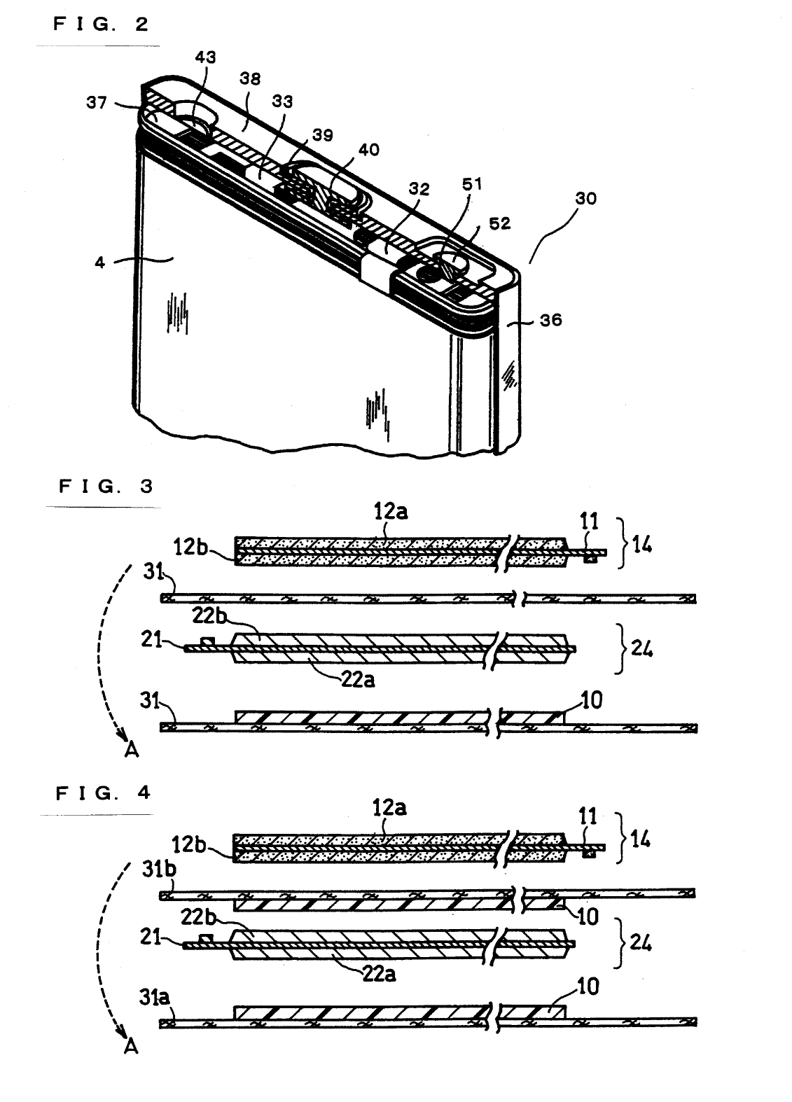

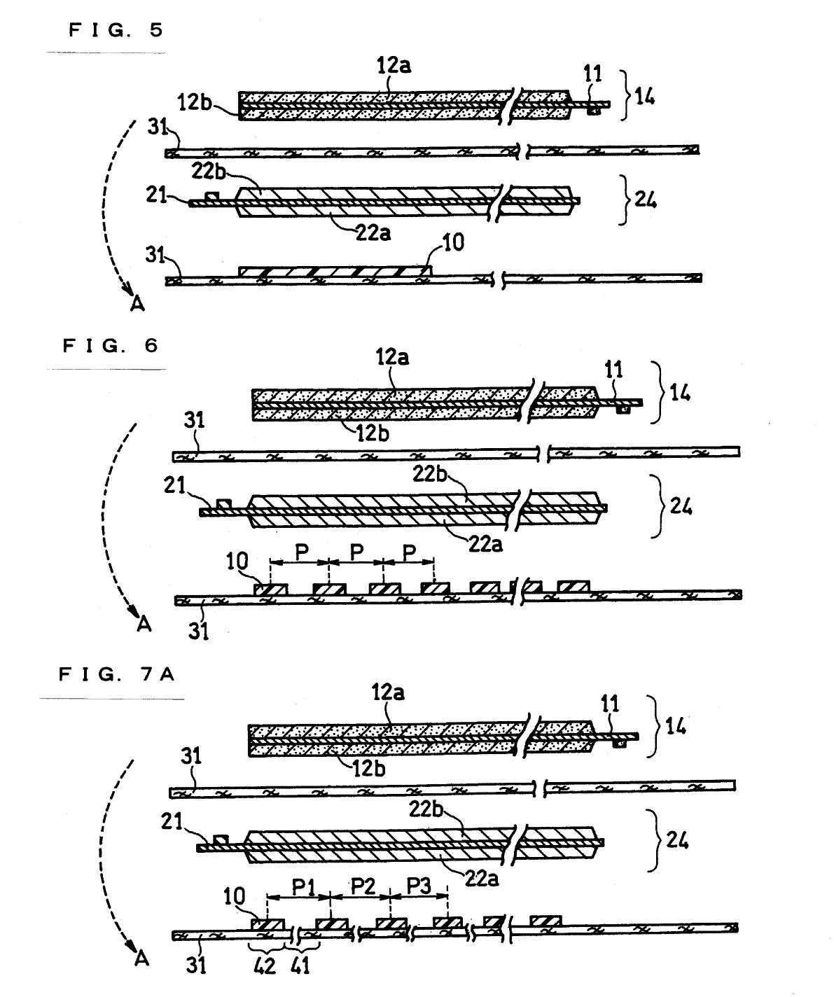

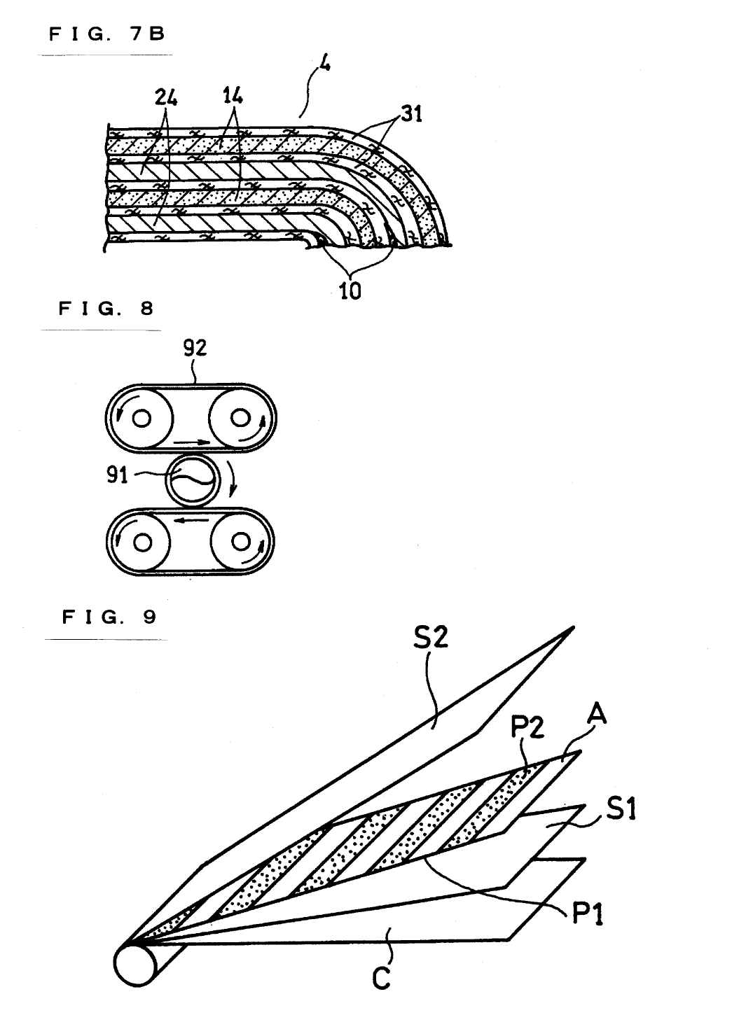

### BRIEF DESCRIPTION OF DRAWINGS

[FIG. 1A] A schematic cross-sectional view of an electrode assembly for a non-aqueous secondary battery according to an embodiment of the present invention.

[FIG. 1B] A partially-enlarged view of a cross section of the electrode assembly of FIG. 1A.

[FIG. 1C] A schematic view to illustrate the constitution of the electrode assembly of FIG. 1B.

[FIG. 2] A partial cut-away perspective view of a prismatic non-aqueous secondary battery according to another embodiment of the present invention.

[FIG. 3] A schematic view to illustrate the constitution of an electrode assembly according to an embodiment of the present invention.

[FIG. 4] A schematic view to illustrate the constitution of an electrode assembly according to another embodiment of the present invention.

[FIG. 5] A schematic view to illustrate the constitution of an electrode assembly according to a further embodiment of the present invention.

[FIG. 6] A schematic view to illustrate the constitution of an electrode assembly according to yet another embodiment of the present invention.

[FIG. 7A] A schematic view to illustrate the constitution of an electrode assembly according to a still further embodiment of the present invention.

[FIG. 7B] A partially-enlarged view of a cross section of the electrode assembly of FIG. 7A.

[FIG. 8] A schematic view to show a part of the process for fabricating a conventional electrode assembly for a non-aqueous secondary battery.

[FIG. 9] An exploded view of a conventional electrode assembly for a non-aqueous secondary battery.

### DESCRIPTION OF EMBODIMENTS

In the following, an embodiment of the present invention will be described with reference to drawings.

As shown in FIG. 1A, an electrode assembly 4 for a non-aqueous secondary battery of the present invention includes: a positive electrode plate 14 in long strip form, including as a positive electrode active material, a composite lithium oxide capable of absorbing and releasing lithium; and a negative electrode plate 24 in long strip form, including as a negative electrode active material, a material capable of absorbing and releasing lithium, in which the positive electrode plate 14 and the negative electrode plate 24 are spirally wound along the longitudinal direction thereof, with a separator 31 in long strip form serving as a porous insulating layer, interposed therebetween. In this embodiment, the electrode assembly 4 is flat, with its end surfaces perpendicular to the winding axis being oblong, and has a flat portion 41, and a bent portion 42 formed at both ends of the flat portion 41.

FIG. 1B is an enlarged view of a relevant part of the electrode assembly 4 of FIG. 1A, and FIG. 1C is a schematic view to illustrate the constitution of the electrode assembly 4 of FIG. 1A. In FIG. 1B, a spacer 10 in film form comprising low-density polyethylene, etc. is disposed between the positive electrode plate 14 and the separator 31, and also between the negative electrode plate 24 and the separator 31. The spacer 10 is disposed continuously along the longitudinal direction of the separator 31 in long strip form. In addition, the low-density polyethylene in the spacer 10 dissolves in a non-aqueous electrolyte containing, as a solvent, carbonic ester such as ethylene carbonate.

As shown in FIG. 1C, the positive electrode plate 14 has a positive electrode current collector 11 in long strip form, and positive electrode active material layers 12a and 12b adhering to both surfaces thereof, respectively. The negative electrode plate 24 has a negative electrode current collector 21 in long strip form, and negative electrode active material layers 22a and 22b adhering to both surfaces thereof, respectively.

As shown in FIG. 1C, the electrode assembly 4 of FIGS. 1A and 1B can be formed by disposing in order: the separator 31 having the spacer 10 adhering to both surfaces thereof; the negative electrode plate 24; another separator 31 having the spacer 10 adhering to both surfaces thereof; and the positive electrode plate 14, and then spirally winding the resultant in a direction A. In FIG. 1C, the spacer 10 has substantially the same length as the active material layers 12a, 12b, 22a, and 22b of the positive electrode plate 14 and the negative electrode plate 24. The spacer 10 may be wound in a state where it is interposed or supported between the positive electrode plate 14 and the separator 31 and/or the negative electrode plate 24 and the separator 31, or may be wound in a state where it is fixed on the surfaces of the separator 31 by adhesion. Alternatively, the spacer 10 may be wound in a state where it adheres to the surface of the positive electrode plate 14 and/or the surface of the negative electrode plate 24. The spacer 10 may adhere to one surface or both surfaces of the positive electrode plate 14, of the negative electrode plate 24, or of the separator 31, or may be supported independently between the above components.

FIG. 2 is a partial cut-away perspective view of a non-aqueous secondary battery using the electrode assembly 4. The prismatic non-aqueous secondary battery 30 shown in FIG. 2 has a battery case 36 which is bottomed and flat, and has an upper end surface and a bottom surface that are oblong. The electrode assembly 4 and a non-aqueous electrolyte (not shown) are put therein.

More specifically, the electrode assembly 4 is housed in the battery case 36, together with an insulating frame member 37. Drawn out from the upper portion of the electrode assembly 4 are a positive electrode lead 32 connected to the positive electrode plate and a negative electrode lead 33 connected to the negative electrode plate. The negative electrode lead 33 is connected to a terminal 40 having an insulating gasket 39 adhering to its peripheral edge, and the positive electrode lead 32 is connected to a sealing plate 38 fit in the opening of the battery case 36. The battery case 36 and the sealing plate 38 are welded together for sealing, along the outer periphery of the opening of the battery case 36. The battery case 36 housing the electrode assembly 4 is injected with a predetermined amount of the non-aqueous electrolyte (not shown), from a sealing plug hole 51 provided on the sealing plate 38. After the injection, a sealing plug 52 is inserted into the sealing plug hole 51, and the sealing plug 52 is then welded to the sealing plate 38. A thin portion 43 is provided on the sealing plate 38 for releasing gas to the outside in the case where a large amount of gas is generated inside the secondary battery 30.

In the non-aqueous secondary battery 30 as above, the spacer 10 comprising a resin dissolvable in the non-aqueous electrolyte is disposed, and therefore, a gap is created between the positive electrode plate 14 and the separator 31 and/or between the negative electrode plate 24 and the separator 31, in the electrode assembly 4, due to the gradual dissolving of the resin caused by its contact with the non-aqueous electrolyte. As such, volume increase of the electrode plate caused with expansion thereof during charge can be absorbed by the gap, and stress to the electrode plate can be made less. Particularly, at the bent portion 42 of the electrode assembly 4, there is usually a large amount of stress to the electrode plate, and therefore, creation of the gap as above is effective in lessening stress. Therefore, breakage and buckling of the electrode plate as well as internal short circuits resulting therefrom can be suppressed, and safety and reliability of the battery can be improved.

In the embodiment shown in FIGS. 1A to 1C, the spacers 10 are disposed on both surfaces of the positive electrode plate and of the negative electrode plate, and therefore, volume increase of the electrode plates due to expansion thereof during charge can be absorbed more effectively. Moreover, since the spacers 10 contact the entire active material layers 12a, 12b, 22a, and 22b, the active material layers can be protected effectively during fabrication of the electrode assembly 4. Further, after fabrication of the non-aqueous secondary battery 30, the gap between the electrode plates can be secured extensively, and breakage and buckling of the electrode plates can be suppressed significantly.

Note that the non-aqueous secondary battery in which at least a part of the spacer 10 dissolves due to its contact with the non-aqueous electrolyte, is also encompassed by the present invention. In the non-aqueous secondary battery as above, the resin constituting the spacer 10 is dissolved in the non-aqueous electrolyte.

FIGS. 3 and 4 are each schematic figures for illustrating other examples of the electrode assembly for a non-aqueous secondary battery. In these embodiments, all is the same as FIGS. 1A and 1C, except for the spacer 10 being disposed on only one surface of the separator 31 so as to contact only the negative electrode plate 24. That is, in FIGS. 3 and 4, the spacer 10 is not in contact with the positive electrode plate 14.

In FIG. 3, the separator 31 having the spacer 10 adhering to one surface thereof is placed over the negative electrode plate 24, so that the spacer 10 contacts only one surface of the negative electrode plate 24. The spacer 10 is disposed so as to contact the surface of the negative electrode plate 24, the surface being the one on the inner side when wound. In addition: the separator 31 having the spacer 10 adhering to the surface thereof on the negative electrode plate 24 side; the negative electrode plate 24; another separator 31 not having the spacer 10 on either side thereof; and the positive electrode plate 14 are wound in this order, in a direction A as indicated in FIG. 3, thereby forming an electrode assembly.

In FIG. 4, the negative electrode plate 24 is interposed between two separators, which are separators 31a and 31b each having the spacer 10 adhering to one surface thereof, in a manner such that the spacer 10 contacts both surfaces of the negative electrode plate 24. The resultant is then wound together with the positive electrode plate 14.

As with FIGS. 1A and 1C, the electrode assemblies of FIGS. 3 and 4 can also be housed as the electrode assembly 4 in the battery case 36, to fabricate the non-aqueous secondary battery 30 shown in FIG. 2.

In addition, as with the above, in the non-aqueous secondary battery which uses the electrode assembly of FIG. 3 or FIG. 4, a gap is created by the dissolving of the spacer 10, and breakage and buckling of the electrode plate can be suppressed effectively. Further, since the spacer 10 is provided on one surface of the separator 31, a gap can be created efficiently with use of a spacer material smaller in amount than in the case where the spacer 10 is provided on both surfaces of the separator 31.

FIG. 5 is a schematic figure to illustrate another example of the electrode assembly for a non-aqueous secondary battery. In FIG. 5, all is the same as FIG. 3, except for the spacer 10 being disposed so as to contact the surface of the negative electrode plate 24, the surface being the one on the inner side when wound, and to be positioned at the innermost portion of the wound electrode assembly.

By disposing the spacer 10 at the innermost portion of the electrode assembly, volume increase of the negative electrode plate 24 can be absorbed effectively thereat where stress is likely to be caused with expansion thereof during charge, with use of a spacer material smaller in amount than in the case where the spacer 10 is disposed on the entire separator 31.

Note that the innermost portion means the part corresponding to the first round of winding, of the positive electrode plate 14, of the negative electrode plate 24, or of the separator 31. In the case of winding with use of a winding core, the length of the spacer 10 at the innermost portion may be substantially the same as the core circumference, or may be made longer in consideration of the thickness of the spacer 10 and the component (the separator 31, in the case of FIG. 5) positioned more inward than the spacer 10. In FIG. 5, the spacer 10 does not necessarily have to be positioned exactly for the entire first round when wound, and may be positioned near the innermost portion. That is, the length of the spacer 10 may be slightly shorter or longer than the length of the innermost portion, and may be, for example, 80 to 120% of the length of the innermost portion.

In the case of disposing the spacer 10 at the innermost portion of the electrode assembly, the length of the spacer 10 can be selected depending on the desired size of the electrode assembly, and is, for example, 10 to 60 mm, preferably 20 to 50 mm, and further preferably 30 to 45 mm.

FIG. 6 is a modified version of the electrode assembly of FIG. 3, and the spacers 10 in strip form are disposed at intervals along the longitudinal direction of the separator 31. In FIG. 6, a plurality of the spacers 10 is disposed at a pitch P between the adjacent spacers, so as to contact the surface of the negative electrode plate 24, the surface being the one on the inner side when wound.

By forming the spacers 10 at intervals, gaps capable of absorbing volume increase of the electrode plate can be obtained effectively, with use of a spacer material smaller in amount than when disposing the spacer 10 on the entire electrode plate. Further, volume increase of the negative electrode plate 24 can be absorbed at areas where remarkably affected by expansion thereof caused with charge.

In the case of forming the spacers 10 at intervals, the degree of exposure (percentage of area of the part not having the spacers on the surface) of the surface (one surface of the separator, in the case of FIG. 6) having the spacers formed thereon is, for example, 10 to 90%, preferably 20 to 80%, and further preferably 30 to 70%. In the case of forming the spacers on the surface of the negative electrode plate or of the positive electrode plate, the degree of exposure of the surface having the spacers formed thereon can be selected from a range similar to the one above.

The pitch P between the adjacent spacers 10 can be selected depending on factors such as the desired size of the electrode assembly, and is, for example, 5 to 35 mm, preferably 10 to 30 mm, and further preferably 15 to 25 mm.

In FIG. 6, the spacers 10 are formed at intervals on the entire surface of the separator 31 in the longitudinal direction thereof. However, they may be formed only at a position where easily stressed, such as near the innermost portion of the electrode assembly or at a position on the inner side of the electrode assembly (e.g., position at half the length of the separator from the start of winding, when wound).

FIG. 7A is a schematic view to illustrate a modified version of the electrode assembly of FIG. 6, and FIG. 7B is an enlarged view of the relevant part of the electrode assembly resulting from FIG. 7A. As illustrated in FIG. 7A, in this embodiment, a plurality of the spacers 10 in strip form are disposed at intervals at different pitches, along the longitudinal direction of the separator 31. In this embodiment also, the spacers 10 are disposed so as to contact the surface of the negative electrode plate 24, the surface being the one on the inner side when wound.

The plurality of the spacers 10 is disposed at intervals at different pitches of P1, P2, and P3, along the longitudinal direction of the separator 31. In this embodiment, when fabricating the electrode assembly, the spacers 10 are disposed so that they are positioned at the bent portion 42 of the electrode assembly, and that the pitch between the adjacent spacers 10 corresponds to the flat portion 41. That is, the pitch is gradually made larger in the order of P1, P2, P3 . . . Pn−1 (not shown. n indicates the number of the spacers 10), from the start toward the end of winding.

As illustrated in FIG. 7B, in the above embodiment, the spacer 10 can be disposed at the bent portion with a small radius of curvature, in the wound electrode assembly (particularly that being flat and having oblong end surfaces) 4. This is because the spacing at the bent portion gradually becomes wider from the innermost toward the outermost. The pitch can be adjusted as appropriate. In the above embodiment, gaps capable of absorbing volume increase of the electrode plate can be obtained effectively, with use of a spacer material smaller in amount than when disposing the spacer 10 on the entire electrode plate. It is advantageous, particularly because volume increase of the negative electrode plate 24 can be absorbed at areas where greatly affected by expansion thereof caused with charge.

FIGS. 1 to 6, 7A, and 7B illustrated electrode assemblies that were flat, with their end surfaces perpendicular to the winding axis being oblong. However, the wound electrode assembly may also be a cylindrical electrode assembly with circular end surfaces.

Moreover, although the electrode assemblies were described in FIGS. 1 to 6, 7A, and 7B with reference to examples each comprising the positive electrode plate, the negative electrode plate, and the porous insulating layer spirally wound together, the present invention is not limited thereto, and also encompasses an electrode assembly stacked in a zigzag-folded manner.

With respect to the electrode assembly such as the above, the positive electrode plate, the negative electrode plate, and the porous insulating layer (separator) are folded in a zigzag manner, with the spacer interposed therebetween at appropriate position(s), as with FIGS. 1 to 6, 7A, and 7B. This enables formation of creases, and flat portions other than the creases.

In the zigzag-folded electrode assembly also, the spacer may be formed on the surface (one surface or both surfaces) of any of the components serving as the positive electrode plate, the negative electrode plate, and the separator. Alternatively, the spacer may be independent and interposed between the components.

The spacer(s) can be formed, continuously or at intervals, on the surface of the component. The positive electrode plate or the negative electrode plate is greatly stressed particularly near the crease, as with the bent portion 42 of the spirally-wound electrode assembly. Therefore, in the case of forming a plurality of the spacers at intervals on the surface of the component, spacing may be adjusted so that the spacers are each positioned near the crease. In this case, the pitch between the adjacent spacers can be selected depending on the desired size of the electrode assembly, and is, for example, 5 to 30 mm, preferably 10 to 25 mm, and further preferably 15 to 23 mm.

In the case of disposing the spacer near the crease, the spacers adjacent thereto may be formed on the opposite surface of the component in an alternate manner so that they would each be positioned on the inner side of the crease, or may be formed on the surface of another component positioned further inwards. For example, the odd-numbered spacers may be disposed on one surface of the separator, and the even-numbered spacers may be disposed on the other surface thereof.

In the following, the components of the present invention will be described in further detail.

(Positive Electrode Plate)

The positive electrode plate includes a positive electrode current collector, and a positive electrode active material layer adhering to the surface of the positive electrode current collector.

The positive electrode current collector may be any known positive electrode current collector for use in non-aqueous secondary batteries, such as metal foil made of, for example, aluminum, aluminum alloys, stainless steel, titanium, or titanium alloys. The thickness of the positive electrode current collector is, for example, 1 to 100 μm, preferably 5 to 70 μm, and further preferably 10 to 50 μm.

The positive electrode active material layer may contain a conductive material, a binder, etc., in addition to a positive electrode active material. The positive electrode active material may be a lithium-containing composite oxide, and examples thereof include composite oxides of: lithium cobaltate or a modified substance thereof (such as a substance in which aluminum or magnesium is solidified with lithium cobaltate); lithium nickelate or a modified substance thereof (such as a substance in which part of nickel in lithium nickelate is replaced with cobalt); and lithium manganate or a modified substance thereof. These positive electrode active materials can be used singly or in a combination of two or more.

Examples of the conductive material include: carbon blacks such as acetylene black, Ketjen black, channel black, furnace black, lamp black, and thermal black; various graphites such as natural graphite and artificial graphite; and conductive fibers such as carbon fibers and metal fibers. These conductive materials may be used singly or in a combination of two or more.

Examples of the binder for the positive electrode include: fluorocarbon resins such as polyvinylidene fluoride (PVdF), a modified polyvinylidene fluoride, and polytetrafluoroethylene (PTFE); styrene-butadiene rubber (SBR) particles or a modified product thereof, and rubber particles having acrylate unit(s); and cellulose-based resins such as carboxymethyl cellulose (CMC). For the above rubber particles, acrylate monomers, acrylate oligomers, or the like in which reactive functional groups are incorporated, may also be employed.

The positive electrode active material layer can be formed by applying on the surface of the positive electrode current collector, a dispersion (positive electrode material mixture coating) in which the positive electrode active material, the conductive material, and the binder are dispersed in an appropriate dispersing medium such as N-methyl-2-pyrollidone, and then drying the resultant. After the drying, the positive electrode plate may be partially or entirely pressed as appropriate to adjust its thickness. The above dispersing can be carried out with use of, for example, various kneaders, besides dispersers such as a planetary mixer. The concentration or viscosity of the dispersion can be adjusted as appropriate, as long as the coating properties thereof do not deteriorate. The application of the dispersion can be carried out by a known coating method, dipping, or the like.

The positive electrode active material layer does not necessarily have to adhere to both surfaces of the positive electrode current collector, and may adhere to one surface thereof. The thickness of the positive electrode active material layer is, for example, 10 to 200 μm, preferably 20 to 150 μm, and further preferably 30 to 120 μm.

The form of the positive electrode plate is not limited to the aforementioned long strip form, and can be selected as appropriate depending on the form of the non-aqueous secondary battery to be fabricated.

(Negative Electrode Plate)

The negative electrode plate includes a negative electrode current collector, and a negative electrode active material layer adhering to the surface of the negative electrode current collector.

The negative electrode current collector may be any known negative electrode current collector for use in non-aqueous secondary batteries, such as metal foil made of, for example, copper, copper alloys, nickel, nickel alloys, or stainless steel. The thickness of the negative electrode current collector is, for example, 1 to 100 μm, preferably 2 to 50 μm, and further preferably 5 to 30 μm.

The negative electrode active material layer contains a negative electrode active material capable of absorbing and releasing lithium ions, and as appropriate, a conductive material (such as the conductive material for the positive electrode, as exemplified above) and a binder.

Examples of the negative electrode active material include: carbon materials such as various natural graphites and artificial graphites; simple substance of silicon or tin; and oxides, alloys, or solid solutions containing silicon or tin, or composite materials thereof (e.g., silicon-based composite materials such as silicide, etc.).

An example of the binder for the negative electrode is the binder for the positive electrode, as exemplified above. In terms of lithium-ion-accepting properties, SBR or modified SBR may be used in a combination with a cellulose-based resin or the like.

The negative electrode active material layer can be formed by a known method, and may be formed by depositing the negative electrode active material on the current collector surface, by a vapor phase method such as vacuum vapor deposition, sputtering, and ion plating. Alternatively, it may be formed in the same manner as the positive electrode active material layer, by using a dispersion (negative electrode material mixture coating) containing the negative electrode active material, the binder, and as appropriate, the conductive material.

The negative electrode active material layer does not necessarily have to adhere to both surfaces of the negative electrode current collector, and may adhere to one surface thereof. The thickness of the negative electrode active material layer is, for example, 10 to 300 μm, preferably 30 to 200 μm, and further preferably 50 to 150 μm.

The form of the negative electrode plate is not limited to the aforementioned long strip form, and can be selected as appropriate depending on the form of the non-aqueous secondary battery to be fabricated.

(Porous Insulating Layer)

The porous insulating layer (separator) may be of any composition as long as it can withstand the usage of a non-aqueous secondary battery, and examples thereof include a porous film or non-woven fabric containing resin, and a porous film containing an inorganic oxide. The resin constituting the separator is a polyolefin resin such as polyethylene and polypropylene. The above resin is required to be different from the resin constituting the spacer and to be hardly-soluble in a non-aqueous electrolyte. Examples of the resin such as the above include high-density polyethylene (polyethylene having a density exceeding 942 kg/m³), ultra-high-molecular-weight polyethylene (such as polyethylene having a weight average molecular weight of one million or more), propylene homopolymer, and ethylene-propylene block copolymer. These resins can be used singly or in a combination of two or more. Particularly preferred among these resins, are the high-density polyethylene (e.g., polyethylene having a density that exceeds 942 kg/m³ and is 1,000 kg/m³ or less, etc.), the ultra-high-molecular-weight polyethylene, the propylene homopolymer, etc. The porous film or non-woven fabric made of resin can be produced by a known method.

An example of the porous film containing an inorganic oxide is a porous film obtained by mixing into the above polyolefin resin, particles of inorganic oxide such as alumina, silica, magnesia, and titania, and then molding the mixture into film form. The porous film can be produced by a known method.

The ratio of the inorganic oxide is, for example, 0.1 to 20 parts by weight, preferably 0.5 to 15 parts by weight, and further preferably 1 to 10 parts by weight, per 100 parts by weight of the polyolefin resin.

The porous insulating layer may be composed of a single layer or a plurality of layers. For example, a porous polyethylene film and a porous polypropylene film may be stacked and used as a two-layered or three-layered separator.

The thickness of the porous insulating layer is, for example, 5 to 100 μm, preferably 7 to 50 μm, and further preferably 10 to 25 μm.

The form of the porous insulating layer is not limited to the aforementioned long strip form, and can be selected as appropriate, depending on the form of the non-aqueous secondary battery to be fabricated, and on the forms of the positive and negative electrode plates.

(Non-Aqueous Electrolyte)

The non-aqueous electrolyte is a solution containing a non-aqueous solvent and a supporting salt dissolved therein. As the non-aqueous electrolyte, a known non-aqueous electrolyte for use in non-aqueous secondary batteries can be used.

Examples of the supporting salt include various lithium compounds such as LiPF₆, LiBF₄, LiClO₄, LiAlCl₄, LiSbF₆, LiSCN, LiCF₃SO₃, LiCF₃CO₂, LiAsF₆, and LiB₁₀Cl₁₀. These lithium compounds can be used singly or in a combination of two or more.

Examples of the non-aqueous solvent include various carbonic esters such as: cyclic carbonates such as ethylene carbonate (EC) and propylene carbonate (PC); and chain carbonates such as dimethyl carbonate (DMC), diethyl carbonate (DEC), and methyl ethyl carbonate (MEC), and cyclic esters such as γ-butyrolactone (GB). These non-aqueous solvents can be used singly or in a combination of two or more.

Among these non-aqueous solvents, EC, MEC, DEC, and DMC are used often, and a mixed solvent of two to four selected from EC, MEC, DEC, and DMC may also be used. For example, a mixed solvent containing EC, MEC, and DEC is preferable. In the mixed solvent, the ratio of each solvent is 10 to 50 wt % for EC, 10 to 50 wt % for MEC, 10 to 50 wt % for DEC, and 10 to 60 wt % for DMC.

The non-aqueous electrolyte may contain a known additive, as appropriate. Examples of the additive include: unsaturated cyclic carbonates such as vinylene carbonate (VC); fluorine-containing cyclic carbonates such as fluoroethylene carbonate; benzenes such as benzene and cyclohexyl benzene (CHB); and phosphazenes. These additives can be used singly or in a combination of two or more. In terms of forming a favorable membrane on the surface of the positive or negative electrode plate to ensure stability during overcharge, it is preferable to use VC, cyclohexyl benzene (CHB), a modified compound thereof, or the like.

(Spacer)

The spacer contains a resin dissolvable in the non-aqueous electrolyte constituting the non-aqueous secondary battery. In general, resin such as the above dissolves in a non-aqueous solvent, for example, EC, PC, or DEC, contained in a non-aqueous electrolyte.

Examples of the resin for the spacer include a polyolefin resin, a fluorocarbon resin, polystyrene, an acrylic resin, polyamide, polyester, polycarbonate, polyphenylene ether, and polyphenylene sulfide. These resins for the spacer can be used singly or in a combination of two or more. These resins differ from the polyolefin resin and the fluorocarbon resin contained in the separator and the active material layer, and are required to have solubility in the solvent (e.g., ethylene carbonate, propylene carbonate, or diethyl carbonate) constituting the non-aqueous electrolyte. Among these resins, the polyolefin resin and the fluorocarbon resin are preferred.

Examples of the polyolefin resin for the spacer include: low-density polyethylenes (ethylene-α-olefin copolymer having a density of lower than 930 kg/m³) such as branched low-density polyethylene (HP-LDPE) and linear low-density polyethylene (LLDPE); medium-density polyethylene (ethylene-α-olefin copolymer having a density of 930 kg/m³ or higher and lower than 942 kg/m³); ethylene-propylene random copolymer; and ethylene-vinyl acetate copolymer. Among these polyolefin resins, the low-density polyethylene is preferred, particularly being that having a density of 910 kg/m³ or higher and lower than 930 kg/m³, and more particularly being that having a density of 910 to 929 kg/m³.

An example of the fluorocarbon resin for the spacer is a copolymer of: a vinyl monomer in which all of the hydrogen atoms therein are replaced with fluorine atoms (or fluorine atoms and chlorine atoms); and a vinyl monomer having hydrogen atoms not replaced with halogen atoms. Specifically, an example thereof is a copolymer of: at least one monomer selected from tetrafluoroethylene, chlorotrifluoroethylene, and hexafluoropropylene; and at least one selected from olefin (such as C₂₋₄ olefin such as ethylene and propylene), vinyl fluoride, and vinylidene fluoride. Among these fluorocarbon resins, the copolymer comprising vinylidene fluoride unit(s) and tetrafluoroethylene unit(s); the copolymer comprising vinylidene fluoride unit(s), tetrafluoroethylene unit(s), and hexafluoropropylene unit(s); and the like, are preferred. Note that in the above copolymers, the ratio of the vinyl monomer unit (s) having hydrogen atoms not replaced with halogen atoms is, for example, 5 to 90 mol %, preferably 7 to 70 mol %, and further preferably 8 to 50 mol %. In the copolymer comprising vinylidene fluoride unit(s), tetrafluoroethylene unit(s), and hexafluoropropylene unit(s), the copolymerizing ratio, that is, the molar ratio of vinylidene fluoride unit(s):tetrafluoroethylene unit(s):hexafluoropropylene unit(s) can be selected from the range of 10 to 35:35 to 70:10 to 30, respectively.

Battery characteristics would not be much affected, even if the resin constituting the spacer such as the polyolefin resin and the fluorocarbon resin dissolves in the non-aqueous electrolyte.

The resin constituting the spacer at least partially (e.g., 30 to 100 wt %) dissolves with respect to a non-aqueous electrolyte. Therefore, in the non-aqueous secondary battery of the present invention, the resin constituting the spacer gradually dissolves when the electrode assembly contacts the non-aqueous electrolyte. That is, in the non-aqueous secondary battery, the resin constituting the spacer is dissolved in the non-aqueous electrolyte.

The solubility of a resin dissolvable in a non-aqueous electrolyte can be expressed in, for example, degree of solubility with respect to a solvent of the electrolyte. The resin constituting the spacer is, for example, preferably a resin having a degree of solubility capable of dissolving in an amount of 3 g or more (e.g., 3 to 20 g) and preferably 5 g or more (e.g., 5 to 15 g), in 100 g of a mixed solvent of EC, MEC, and DEC at 25° in a weight ratio of 20:30:50.

The spacer is disposed at least between the positive electrode plate and the porous insulating layer or between the negative electrode plate and the porous insulating layer. The spacer may be formed on the surface of the component(s) serving as the positive electrode plate, the negative electrode plate, and/or the separator. The spacer may be formed on only one surface or both surfaces of the component. Alternatively, the spacer may be interposed independently between the components.

The spacer may be disposed so as to contact at least a part of the surface of the positive or negative electrode plate, or so as to contact the entire positive or negative electrode plate.

One or a plurality of the spacers can be disposed on the surface of the positive or negative electrode plate, or of the separator. For example, the spacer may be disposed continuously or a plurality of the spacers may be disposed at intervals, on the surface of the electrode plate in long strip form, along the longitudinal direction thereof. The plurality of the spacers may be randomly disposed at irregular pitches. However, in general, they are preferably disposed at regular pitches.

The spacer is preferably disposed, particularly at a position easily stressed during fabrication of the electrode assembly, such as near the innermost portion of the wound electrode assembly or at the bent portion thereof, or near the crease of the zigzag-folded electrode assembly. Alternatively, the plurality of the spacers may also be disposed intensively at these parts.

In the electrode assembly having oblong end surfaces, the radius of curvature at the bent portion gradually becomes larger from the innermost toward the outermost of the wound electrode assembly, and therefore, the spacer may be disposed at a part on the inner side where the radius of curvature is relatively small (e.g., part corresponding to 50% of or smaller than the radius of curvature at the outermost). The spacer may be disposed at the entire bent portion or at a part of the bent portion (e.g., near the center of the bent portion). Alternatively, the spacer may be disposed in a manner such that both of its ends stick out toward the flat portion, so as to cover the entire bent portion.

In the case of forming the spacer on the surface of the component, the spacer can be formed in a manner such that it adheres to the surface of the positive electrode plate, of the negative electrode plate, or of the separator, by applying thereto a solution or dispersion containing the constituents of the spacer, and then removing the solvent. Alternatively, the spacer may be formed by molding the constituents of the spacer into film form by a known method such as extrusion molding, and then cutting the resultant spacer in film form to an appropriate size and adhering it, with an adhesive or the like, to the surface of the positive electrode plate, of the negative electrode plate, or of the separator. Note that, further alternatively, the spacer in film form may be formed by applying to a peeling surface of a liner, a solution or dispersion containing the constituents of the spacer, and then removing the solvent to peel the film from the liner.

The spacer may contain a composite comprising the resin and fiber. Examples of the fiber include fiber of polyolefin resin such as polyethylene and polypropylene as exemplified as the material for the separator, polyamide fibers (such as aromatic polyamide fibers such as aramid fibers), polyester fibers, polyimide fibers, polyamide imide fibers, and fibrous cellulose derivatives. These fibers can be used singly or in a combination of two or more.

The spacer can be the resultant obtained by mixing the resin and the fiber, and then molding the mixture into film form by a known method (such as the aforementioned method of molding into film form). Alternatively, the spacer may comprise a composite comprising a fiber sheet such as a non-woven fabric or woven fabric made of the fiber, which is impregnated with the resin. Further alternatively, it may be a composite comprising a fiber sheet such as a non-woven fabric or woven fabric, which is impregnated with the resin.

The ratio of the fiber is, for example, 5 to 10,000 parts by weight, preferably 10 to 8,000 parts by weight, and further preferably 50 to 6,000 parts by weight, per 100 parts by weight of the resin.

When the fiber sheet impregnated with the resin is used as the spacer, the fiber sheet remains in the non-aqueous secondary battery even after the resin dissolves, and a gap can be secured therein. Therefore, since breakage or buckling of the electrode plate can be suppressed more effectively and an insulating layer can be formed, heat generation caused by internal short circuits can be further suppressed.

The thickness of the spacer can be selected from the range of, for example, 1 to 30 μm, preferably 2 to 20 μm, and further preferably 3 to 15 μm, depending on the desired gap width, the kind of the constituent resin, and the like. By using the spacer having a thickness that is within the above range, a gap can be formed more effectively, and breakage and buckling of the positive or negative electrode plate, as well as internal short-circuits caused thereby, can be suppressed.

### EXAMPLES

In the following, the present invention will be described with reference to Examples and Comparative Examples. However, it should be noted that the present invention is not limited to these Examples.

### Example 1

The following steps were taken to fabricate an electrode assembly as shown in FIG. 3, and a prismatic non-aqueous secondary battery 30 as shown in FIG. 2 with use of this electrode assembly.

(1) Production of Positive Electrode Plate

One hundred parts by weight of lithium cobaltate serving as an active material, 2 parts by weight of acetylene black serving as a conductive material, and 2 parts by weight of polyvinylidene fluoride (PVdF) serving as a binder were stirred and kneaded with a double-arm kneader, together with a proper amount of N-methyl-2-pyrollidone, thereby preparing a positive electrode material mixture coating.

The positive electrode material mixture coating was applied to both surfaces of aluminum foil (thickness: 15 μm) serving as a positive electrode current collector 11, and then dried, thereby forming positive electrode active material layers. The thicknesses of the positive electrode active material layers after being dried were 100 μm each. Next, pressing was carried out to make the thicknesses of the positive electrode active material layers 75 μm each and the total thickness of the positive electrode plate 165 μm. Then, slitting was carried out to make the width suitable for a prismatic non-aqueous secondary battery, thereby producing a positive electrode plate 14.

(2) Production of Negative Electrode Plate

One hundred parts by weight of artificial graphite serving as an active material, 2.5 parts by weight of a dispersion (solid content: 40 wt %) of styrene-butadiene rubber particles serving as a binder (the amount being 1 part by weight when the binder is converted to solid content), and 1 part by weight of carboxymethyl cellulose serving as a thickener were stirred with a double-arm kneader, together with a proper amount of water, thereby preparing a negative electrode material mixture coating.

The negative electrode material mixture coating was applied to both surfaces of copper foil (thickness: 10 μm) serving as a negative electrode current collector 21, and then dried, thereby forming negative electrode active material layers. The thicknesses of the negative electrode active material layers after being dried were 110 μm each. Next, pressing was carried out to make the thicknesses of the negative electrode active material layers 85 μm each and the total thickness of the negative electrode plate 180 μm. Then, slitting was carried out to make the width suitable for a prismatic non-aqueous secondary battery, thereby producing a negative electrode plate 24.

(3) Production of Spacer

A vinylidene fluoride.tetrafluoroethylene.hexafluoropropylene copolymer (THV) having a thickness of 10 μm (5 g being the amount of resin which dissolves (degree of solubility) in 100 g of a mixed solvent of: vinylidene fluoride, tetrafluoroethylene, and hexafluoropropylene in a weight ratio of 35:35:30; and EC, MEC, and DEC at 25° C. in a weight ratio of 20:30:50) was cut to the width of the negative electrode plate 24 and the length of the negative electrode active material layer 22a, thereby producing a spacer 10.

(4) Fabrication of Non-Aqueous Secondary Battery

The prismatic non-aqueous secondary battery 30 as shown in FIG. 2 was fabricated with use of the positive electrode plate 14, the negative electrode plate 24, and the spacer 10 produced in (1) to (3) above, respectively, and separators 31.

More specifically, as shown in FIG. 3, the positive electrode plate 14, the separator 31 (20 μm-thick microporous polyethylene film), the negative electrode plate 24, and the separator 31 (20 μm-thick microporous polyethylene film) having the spacer 10 adhered thereto by heat sealing its ends thereto, were disposed in this order, so that the spacer 10 would contact the negative electrode active material layer 22a. The resultant was then wound in a direction A of FIG. 3. That is, a flat electrode assembly 4 was fabricated in a manner such that it was spirally wound, with the separator 31 in contact with the spacer 10 being the innermost layer, and then compressed (pressure: 39.2 MPa) in a direction perpendicular to the winding axis. Note that the width of a flat portion of the innermost portion was 25 mm. 100 electrode assemblies were fabricated in the same manner as above.

Sixty out of the 100 electrode assemblies 4 were each housed together with an insulating plate 37, inside a bottomed and flat battery case 36. A negative electrode lead 33 drawn out from the upper portion of the electrode assembly 4 was connected to a terminal 40 around which an insulating gasket 39 was attached, and a positive electrode lead 32 drawn out from the upper portion of the electrode assembly 4 was connected to a sealing plate 38. Next, the sealing plate 38 was inserted in the opening of the battery case 36, and the battery case 36 and the sealing plate 38 were welded together along the periphery of the opening of the battery case 36 for sealing. A predetermined amount of a non-aqueous electrolyte (not shown) was injected into the battery case 36 from a sealing plug hole 51, and then, a sealing plug 52 was welded to the sealing plate 38, thereby fabricating a prismatic non-aqueous secondary battery 30. The non-aqueous electrolyte was prepared by making LiPF₆ dissolve in a mixed solvent of EC, MEC, and DEC in a weight ratio of 20:30:50, so that the concentration would become 1.0 mol/L.

### Example 2

The following steps were taken to fabricate an electrode assembly as shown in FIG. 4, and a prismatic non-aqueous secondary battery 30 as shown in FIG. 2 with use of this electrode assembly.

For a positive electrode plate 14, a negative electrode plate 24, and separators 31a and 31b, those same as the ones in Example 1 were used. Spacers 10 were each produced by cutting a vinylidene fluoride.tetrafluoroethylene.hexafluoropropylene copolymer (THV) having a thickness of 5 μm, to the width of the negative electrode plate 24, and to the length of negative electrode active material layers 22a and 22b. Adhesion of the spacers to the separators was made possible by heat sealing their ends thereto.

The positive electrode plate 14, the separator 31b having the spacer 10 adhering thereto, the negative electrode plate 24, and the separator 31a having the spacer 10 adhering thereto were disposed in this order, so that the two spacers 10 would contact negative electrode active material layers 22a and 22b, respectively, the layers being formed on both surfaces of the negative electrode plate 24, respectively. The resultant was then wound in a direction A of FIG. 4. That is, a flat electrode assembly 4 was fabricated by spirally winding the same so that the separator 31a would become the innermost layer. 100 electrode assemblies were fabricated in the same manner as above.

The resultant electrode assemblies were used to fabricate 60 prismatic non-aqueous secondary batteries, as with Example 1.

### Example 3

The following steps were taken to fabricate an electrode assembly as shown in FIG. 6, and a prismatic non-aqueous secondary battery 30 as shown in FIG. 2 with use of this electrode assembly.

For a positive electrode plate 14, a negative electrode plate 24, and separators 31, those same as the ones in Example 1 were used. Spacers 10 were each produced by cutting a vinylidene fluoride.tetrafluoroethylene.hexafluoropropylene copolymer (THV) (5 g being the amount of resin which dissolves (degree of solubility) in 100 g of a mixed solvent of: vinylidene fluoride, tetrafluoroethylene, and hexafluoropropylene in a weight ratio of 35:35:30; and EC, MEC, and DEC at 25° C. in a weight ratio of 20:30:50) to the width of the negative electrode plate 24 and a length of 10 mm. Adhesion of the spacers to the separator was made possible by heat sealing their ends thereto.

The positive electrode plate 14, the negative electrode plate 24, and the separator 31 having a plurality of the spacers 10 adhering thereto were disposed in this order, so that the spacers 10 contact a negative electrode active material layer 22a. The resultant was then wound in a direction A of FIG. 6. That is, a flat electrode assembly 4 was fabricated by spirally winding the same, so that the separator 31 having the spacers 10 adhering thereto would become the innermost layer. 100 electrode assemblies were fabricated in the same manner as above. Adhesion of the spacers 10 to the surface of the separator 31 was made possible by heat sealing at a pitch P of 20 mm therebetween, the number of the spacers 10 being as many as such that can be disposed at all bent portions.

The resultant electrode assemblies were used to fabricate 60 prismatic non-aqueous secondary batteries, as with Example 1.

### Example 4

The following steps were taken to fabricate an electrode assembly as shown in FIG. 3, and a prismatic non-aqueous secondary battery 30 as shown in FIG. 2 with use of this electrode assembly.

For a positive electrode plate 14, a negative electrode plate 24, and separators 31, those same as the ones in Example 1 were used. A spacer 10 was produced by cutting a low-density polyethylene (PE) film (5 g being the amount of resin which dissolves (degree of solubility) in 100 g of a mixed solvent of EC, MEC, and DEC at 25° C. in a weight ratio of 20:30:50) having a thickness of 10 μm and a molecular weight of 282, to the width of the negative electrode plate 24 and the length of a negative electrode active material layer 22a. Adhesion of the spacer to the separator was made possible by heat sealing its ends thereto.

The positive electrode plate 14, the separator 31, the negative electrode plate 24, and the separator 31 having the spacer 10 adhering thereto were disposed in this order, so that the spacer 10 would contact the negative electrode active material layer 22a. The resultant was then wound in a direction A of FIG. 3. That is, a flat electrode assembly 4 was fabricated by spirally winding the same, so that the separator 31 having the spacer 10 adhering thereto would become the innermost layer. 100 electrode assemblies were fabricated in the same manner as above.

The resultant electrode assemblies were used to fabricate 60 prismatic non-aqueous secondary batteries, as with Example 1.

### Example 5

The following steps were taken to fabricate an electrode assembly as shown in FIG. 3, and a prismatic non-aqueous secondary battery 30 as shown in FIG. 2 with use of this electrode assembly.

For a positive electrode plate 14, a negative electrode plate 24, and separators 31, those same as the ones in Example 1 were used. A spacer 10 was produced by cutting a fiber-reinforced resin film made of a non-woven fabric (thickness: 10 μm) of aramid fiber impregnated with vinylidene fluoride.tetrafluoroethylene.hexafluoropropylene copolymer (THV) (impregnated THV content (converted to solid content): 2 g per 100 g of the non-woven fabric), to the width of the negative electrode plate 24 and the length of a negative electrode active material layer 22a. Adhesion of the spacer to the separator was made possible by heat sealing its ends thereto.

The positive electrode plate 14, the separator 31, the negative electrode plate 24, and the separator 31 having the spacer 10 adhering thereto were disposed in this order, so that the spacer 10 would contact the negative electrode active material layer 22a. The resultant was then wound in a direction A of FIG. 3. That is, a flat electrode assembly 4 was fabricated by spirally winding the same, so that the separator 31 in contact with the spacer 10 would become the innermost layer. 100 electrode assemblies were fabricated in the same manner as above.

The resultant electrode assemblies were used to fabricate 60 prismatic non-aqueous secondary batteries, as with Example 1.

### Example 6

The following steps were taken to fabricate an electrode assembly as shown in FIG. 5, and a prismatic non-aqueous secondary battery 30 as shown in FIG. 2 with use of this electrode assembly.

For a positive electrode plate 14, a negative electrode plate 24, and separators 31, those same as the ones in Example 1 were used. A spacer 10 was produced by cutting a vinylidene fluoride.tetrafluoroethylene.hexafluoropropylene copolymer (THV) having a thickness of 10 μm, to the width of the negative electrode plate 24 and a length of 50 mm. Adhesion of the spacer to the separator was made possible by heat sealing its ends thereto.

The positive electrode plate 14, the separator 31, the negative electrode plate 24, and the separator 31 having the spacer 10 adhering thereto were disposed in this order, so that the spacer 10 would contact a negative electrode active material layer 22a at the innermost portion of the wound electrode assembly. The resultant was then wound in a direction A of FIG. 5. That is, a flat electrode assembly 4 was fabricated by spirally winding the same, so that the separator 31 having the spacer 10 adhering thereto would become the innermost layer. 100 electrode assemblies were fabricated in the same manner as above.

The resultant electrode assemblies were used to fabricate 60 prismatic non-aqueous secondary batteries, as with Example 1.

### Example 7

The following steps were taken to fabricate an electrode assembly as shown in FIG. 7A, and a prismatic non-aqueous secondary battery 30 as shown in FIG. 2 with use of this electrode assembly.

For a positive electrode plate 14, a negative electrode plate 24, and separators 31, those same as the ones used in Example 1 were used. Spacers 10 were each produced by cutting a vinylidene fluoride.tetrafluoroethylene.hexafluoropropylene copolymer (THV) having a thickness of 10 μm, to the width of the negative electrode plate 24 and a length of 10 mm. Adhesion of the spacers to the separator was made possible by heat sealing their ends thereto.

The positive electrode plate 14, the separator 31, the negative electrode plate 24, and the separator 31 having a plurality of the spacers 10 adhering thereto were disposed in this order, so that the spacers 10 would contact a negative electrode active material layer 22a. The resultant was then wound in a direction A of FIG. 7A. That is, a flat electrode assembly 4 was fabricated by spirally winding the same, so that the separator 31 having the spacers 10 adhering thereto would become the innermost layer. 100 electrode assemblies were fabricated in the same manner as above.

The resultant battery assemblies were used to fabricate 60 prismatic non-aqueous secondary batteries, as with Example 1.

For the spacers 10 to be positioned at all bent portions after winding, adhesion of the same to the surface of the separator 31 was made possible in a manner such that the pitch therebetween would increase in order at 1 mm increments, with a pitch P1 being 20 mm, followed by a pitch P2 of 21 mm and a pitch P3 of 22 mm. The width of a flat portion of the innermost portion of the electrode assembly was 25 mm.

### Comparative Example 1

One hundred prismatic non-aqueous secondary batteries were each fabricated in the same manner as Example 1, except for fabricating the electrode assembly without use of the spacer.

### Comparative Example 2

One hundred prismatic non-aqueous secondary batteries were each fabricated in the same manner as Example 1, except for using as the spacer 10, a high-density polyethylene (PE) film having a thickness of 10 μm and a molecular weight of 28,000. The PE film used was not dissolvable in the non-aqueous electrolyte.

Table 1 shows the spacer thickness, the location where the spacer contacts the negative electrode plate, the manner in which the spacer is disposed, and the spacer material, for each of the above Examples and Comparative Examples.

TABLE 1

| | | | Manner | |
|---|---|---|---|---|
| | Thickness | | in which | |
| | (μm) | Location | disposed | Material |
| Ex. 1 | 10 | One surface of | Continuously | THV |
| | | negative electrode plate | | |
| Ex. 2 | 5 | Both surfaces of | Continuously | THV |
| | | negative electrode plate | | |
| Ex. 3 | 10 | One surface of | At intervals | THV |
| | | negative electrode plate | | |
| Ex. 4 | 10 | One surface of | Continuously | Low- |
| | | negative electrode plate | | density PE |
| Ex. 5 | 10 | One surface of | Continuously | Aramid |
| | | negative electrode plate | | fiber and |
| | | | | THV |
| Ex. 6 | 10 | One surface of negative | — | THV |
| | | electrode plate, | | |
| | | and innermost portion | | |
| Ex. 7 | 5 | One surface of | At intervals | THV |
| | | negative electrode plate, | | |
| | | and bent portions | | |
| Comp. | None | None | None | None |
| Ex. 1 | | | | |
| Comp. | 10 | One surface of | Continuously | High- |
| Ex. 2 | | negative electrode plate | | density PE |

### EVALUATION

The following evaluation was performed on the electrode assemblies and prismatic non-aqueous secondary batteries of the Examples and Comparative Examples.

(Defects in Electrode Assembly (1))

Among the electrode assemblies obtained in each of the Examples and Comparative Examples, 40 electrode assemblies not subjected to battery fabrication were disassembled, to observe whether or not there were any defects therein such as breakage, separation of the material mixture, etc., after winding. The number of the electrode assemblies with defects observed therein was expressed in percentage.

(Capacity Retention Rate)

With respect to the 60 prismatic non-aqueous secondary batteries of each of the Examples and Comparative Examples, the capacity after 500 cycles of repeated charge and discharge was measured, and the capacity retention rate relative to the initial capacity was calculated.

(Thickness of Electrode Assembly)

With respect to the prismatic non-aqueous secondary batteries of each of the Examples and Comparative Examples, charge and discharge were repeated for 500 cycles, and then, 30 of the batteries were disassembled. The average thickness of the electrode assembly was calculated. From this average, the average thickness of 40 electrode assemblies not subjected to battery fabrication was subtracted, thereby obtaining the change in thickness caused due to the charge and discharge.

(Defects in Electrode Assembly (2))

With respect to the 30 batteries disassembled as above, the electrode assembly was disassembled, and observation was made whether or not there were any defects in the electrode plate, such as breakage, buckling, lithium deposition, and separation of the material mixture. The number of the electrode assemblies with these defects observed therein was expressed in percentage.

(Distance Between Positive Electrode Current Collector at Bent Portion)

With respect to the prismatic non-aqueous secondary batteries of each of the Examples and Comparative Examples, an image of a cross section at the center in the longitudinal direction was taken by using CT, and the distance between the positive electrode current collector at a bent portion created due to winding was calculated. The distance therebetween was calculated at the initial state of discharge, and also at the state of charge after 100 cycles of repeated charge and discharge.

(Drop Test)

Ten prismatic non-aqueous secondary batteries were subjected to 500 cycles of repeated charge and discharge, followed by two hours of charge at a current of 2 A with an upper voltage limit of 4.2 V.

Next, each battery was dropped 10 times per surface of its six surfaces toward a concrete surface, from a height of 1.5 m. The temperatures of the ten batteries were measured at a room temperature of 25° C., followed by observation of whether or not heat was generated, and the average of the battery temperature was obtained.

(Rod Crush Test)

Ten prismatic non-aqueous secondary batteries were subjected to 500 cycles of repeated charge and discharge, followed by two hours of charge at a current of 2 A with an upper voltage limit of 4.2 V.

Next, each battery was laid down and subjected to a crush test (crush speed: 5 mm/sec) with use of a 10 mm-diameter rod, in a direction perpendicular to the longitudinal direction of the battery. The temperatures of the ten batteries were measured at a room temperature of 25° C., and the average was obtained.

(Heating Test)

Ten prismatic non-aqueous secondary batteries were subjected to 500 cycles of repeated charge and discharge, followed by two hours of charge at a current of 2 A with an upper voltage limit of 4.2 V.

Next, each battery was put in a constant temperature chamber. The temperature in the constant temperature chamber was then increased at 5° C./min from room temperature up to 150° C., at which the battery temperature was measured, and the average for the ten batteries was obtained.

Tables 2 and 3 show the results of the above evaluation.

TABLE 2

| | | | | | Distance between | |
|---|---|---|---|---|---|---|
| | | | | | positive | |
| | | | | | electrode current | |
| | Defect occurrence | | | | collector (μm) | |
| | rate | | | | | State of |
| | (%) | | Capacity | Change | Initial | charge |
| | | After | retention | in | state of | after |
| | After | charge and | rate | thickness | dis- | 100 |
| | winding | discharge | (%) | (mm) | charge | cycles |
| Ex. 1 | 0 | 0 | 88 | 0.1 | 202.5 | 202.5 |
| Ex. 2 | 0 | 0 | 86 | 0.1 | 202.5 | 202.5 |
| Ex. 3 | 0 | 0 | 87 | 0.2 | 202.5 | 202.5 |
| Ex. 4 | 0 | 0 | 89 | 0.1 | 202.5 | 202.5 |
| Ex. 5 | 0 | 0 | 88 | 0.2 | 202.5 | 202.5 |
| Ex. 6 | 0 | 0 | 86 | 0.15 | 202.5 | 202.5 |
| Ex. 7 | 0 | 0 | 89 | 0.1 | 202.5 | 202.5 |
| Comp. | 10 | 60 | 73 | 0.6 | 192.5 | 207.5 |
| Ex. 1 | | | | | | |
| Comp. | 0 | 65 | 75 | 0.7 | 202.5 | 205.5 |
| Ex. 2 | | | | | | |

As shown in Table 2, none of the electrode assemblies of Examples 1 to 7 showed defects such as breakage of the electrode plate and separation of the electrode active material layer, in both the positive electrode plate 14 and the negative electrode plate 24. Further, defects such as lithium deposition, breakage of the electrode plate, buckling of the electrode plate, and separation of the electrode active material layer were not observed, even after the 500 cycles of charge and discharge. On the other hand, the spacer(s) in the electrode assemblies of the Examples were completely dissolved after the charge and discharge. That is, gap(s) were created between the electrode plate and the separator due to the dissolving of the spacer(s), and served to absorb expansion of the negative electrode plate caused with charge, in the case where such expansion occurred. It is therefore considered that, even after the charge and discharge, defects such as breakage and buckling of the electrode plate and separation of the active material layer were suppressed.

The electrolyte in each of the non-aqueous secondary batteries was checked by high performance liquid chromatography, and the dissolving of the resin (THV or low-density polyethylene) constituting the spacer was observed.

Moreover, the electrode assemblies of the Examples had high capacity retention rates, even after 500 cycles of charge and discharge.

With respect to the electrode assemblies of the Examples, increase in thickness after the charge and discharge was small, and buckling was suppressed. This is considered to be why favorable battery characteristics were able to be maintained. Further, the distance between the positive electrode current collector did not change, even at the state of charge where the negative electrode plate usually expands. This is considered to be due to the above gap(s) having been able to absorb volume increase of the negative electrode caused with expansion thereof due to charge.

On the other hand, in Comparative Examples 1 to 2, capacity retention rates declined remarkably after 500 cycles of charge and discharge. After the charge and discharge, defects such as lithium deposition, breakage of the electrode plate, buckling of the electrode plate, and separation of the electrode active material layer were observed at a high rate. After the charge and discharge, there was also a large increase in the thicknesses of the electrode assemblies. From a CT image, buckling of the electrode plate was found to be occurring at the state of charge. At the state of charge, the distance between the positive electrode current collector was also large compared to that at the initial state, and this is considered to be due to volume increase of the negative electrode caused with expansion thereof due to charge.

The spacer inside the electrode assembly of Comparative Example 2 remained without dissolving, even after the charge and discharge. In Comparative Example 1, the electrode assembly was formed without use of the spacer, and in Comparative Example 2, the spacer did not dissolve, and therefore, a gap could not be created inside the electrode assembly. Thus, it is considered that even when the negative electrode expanded due to charge, its volume increase was unable to be absorbed.

TABLE 3

| | Temperature at which heat generated (° C.) | | |
|---|---|---|---|
| | Drop test | Rod crush test | Heating test |
| Ex. 1 | 25° C. | 25° C. | 150° C. |
| | (heat not generated) | (heat not generated) | (heat not generated) |
| Ex. 2 | 25° C. | 25° C. | 150° C. |
| | (heat not generated) | (heat not generated) | (heat not generated) |
| Ex. 3 | 25° C. | 25° C. | 150° C. |
| | (heat not generated) | (heat not generated) | (heat not generated) |
| Ex. 4 | 25° C. | 25° C. | 150° C. |
| | (heat not generated) | (heat not generated) | (heat not generated) |
| Ex. 5 | 25° C. | 25° C. | 150° C. |
| | (heat not generated) | (heat not generated) | (heat not generated) |
| Ex. 6 | 25° C. | 25° C. | 150° C. |
| | (heat not generated) | (heat not generated) | (heat not generated) |
| Ex. 7 | 25° C. | 25° C. | 150° C. |
| | (heat not generated) | (heat not generated) | (heat not generated) |
| Comp. | 50° C. | 120° C. | 170° C. |
| Ex. 1 | (heat generated) | (heat generated) | (heat generated) |
| Comp. | 50° C. | 120° C. | 170° C. |
| Ex. 2 | (heat generated) | (heat generated) | (heat generated) |

From the results on Table 3, defects were not observed in Examples 1 to 7, even in respect to the drop test, rod crush test, and 150° C. heating test, each performed after 500 cycles. This is considered to show that favorable level of safety was able to be maintained, since buckling was suppressed, and internal short circuits caused thereby was able to be suppressed as a result. Note that in Example 5, aramid fiber was added to the constituent resin of the spacer. This enables formation of an insulating layer due to the aramid fiber remaining even when the resin dissolves. Thus, greater effect can be obtained with respect to level of safety.

On the other hand, in the non-aqueous secondary batteries of Comparative Examples 1 and 2, the temperatures at which heat generated were remarkably high in all of the drop test, rod crush test, and 150° C. heating test. This is considered to be due to occurrence of internal short circuits and buckling, resulting from defects caused with expansion of the negative electrode plate which is caused by winding as well as by charge and discharge.

As evident from the above results, if an electrode assembly is formed by utilizing a spacer which uses a material dissolvable in a non-aqueous electrolyte, a gap created by the dissolving of the material can absorb volume increase of the negative electrode caused by expansion thereof during charge, and this enables suppression of buckling as well as internal short circuits caused with the buckling. Note that a gap was created between the negative electrode plate and the separator in Examples 1 to 7, although not limited thereto. It goes without saying that similar effects can be achieved, even if a gap is created only between the positive electrode plate and the separator, or in the alternative, between the positive electrode plate and the separator and also between the negative electrode plate and the separator.

Moreover, Examples 1 to 7 were examples which used as the spacer, a resin completely dissolvable in the non-aqueous electrolyte, so as to create a gap at least between the positive electrode plate and the separator or between the negative electrode plate and the separator as described above. However, it is not limited to the above, and it goes without saying that similar effects can be achieved, even when the material constituting the spacer partially remains.

In Examples 1 to 7, although spirally-wound electrode assemblies were fabricated, it goes without saying that similar effects can be achieved, even with an electrode assembly stacked in a zigzag-folded manner. Further, although the Examples were described with use of prismatic non-aqueous secondary batteries, it goes without saying that similar effects can be achieved, even with a cylindrical non-aqueous secondary battery.

Although the present invention has been described in terms of the presently preferred embodiments, it is to be understood that such disclosure is not to be interpreted as limiting. Various alterations and modifications will no doubt become apparent to those skilled in the art to which the present invention pertains, after having read the above disclosure. Accordingly, it is intended that the appended claims be interpreted as covering all alterations and modifications as fall within the true spirit and scope of the invention.

### INDUSTRIAL APPLICABILITY

The electrode assembly for a non-aqueous secondary battery according to the present invention is fabricated in a manner such that a spacer, made of resin dissolvable in a non-aqueous electrolyte and capable of creating a gap, is disposed at least between a positive electrode plate and a porous insulating layer or between a negative electrode plate and the porous insulating layer, thereby enabling absorbing of volume increase of the negative electrode which is due to expansion thereof during charge, and further enabling suppression of buckling of the electrode plate. Moreover, use of this electrode assembly enables suppression of heat generation which is due to internal short circuits caused by buckling of the electrode plate, thereby providing a non-aqueous secondary battery with high level of safety, being useful as the power source for portable devices of which higher capacity is demanded in accordance with increased functions in electronic devices and communication devices, and as other power sources also.

### REFERENCE SIGNS LIST

4 electrode assembly for non-aqueous secondary battery
10 spacer
11 positive electrode current collector
12a, 12b positive electrode active material layer
14 positive electrode plate
21 negative electrode current collector
22a, 22b negative electrode active material layer
24 negative electrode plate
30 prismatic non-aqueous secondary battery
31, 31a, 31b separator
32 positive electrode lead
33 negative electrode lead
36 battery case
37 insulating plate
38 sealing plate
39 insulating gasket
40 terminal
52 sealing plug hole
51 sealing plug
A winding direction of electrode assembly
P, P1, P2, P3 pitch

1. A non-aqueous secondary battery comprising:
a positive electrode plate including a positive electrode current collector in long strip form, and a positive electrode active material layer adhering to a surface of the positive electrode current collector;
a negative electrode plate including a negative electrode current collector in long strip form, and a negative electrode active material layer adhering to a surface of the negative electrode current collector;
a porous insulating layer interposed between the positive electrode plate and the negative electrode plate;
a non-aqueous electrolyte; and
a spacer in film form disposed at least between the positive electrode plate and the porous insulating layer or between the negative electrode plate and the porous insulating layer, the spacer comprising a resin dissolvable in the non-aqueous electrolyte.

2. The non-aqueous secondary battery in accordance with claim 1, wherein the resin is at least one selected from the group consisting of a polyolefin resin and a fluorocarbon resin.

3. The non-aqueous secondary battery in accordance with claim 2, wherein the polyolefin resin comprises low-density polyethylene having a density of lower than 930 kg/m³.

4. The non-aqueous secondary battery in accordance with claim 2, wherein the fluorocarbon resin comprises a copolymer containing a vinylidene fluoride unit, a tetrafluoroethylene unit, and a hexafluoropropylene unit.

5. The non-aqueous secondary battery in accordance with claim 1, wherein the positive electrode plate, the negative electrode plate, and the porous insulating layer are either spirally wound, or stacked in a zigzag-folded manner, along the longitudinal direction thereof, thereby constituting an electrode assembly.

6. The non-aqueous secondary battery in accordance with claim 5, wherein the spacer is disposed continuously along the longitudinal direction of the porous insulating layer.

7. The non-aqueous secondary battery in accordance with claim 6, wherein the spacer is disposed near the innermost portion of the spirally-wound electrode assembly.

8. The non-aqueous secondary battery in accordance with claim 5, wherein a plurality of the spacers is disposed at intervals along the longitudinal direction of the porous insulating layer.

9. The non-aqueous secondary battery in accordance with claim 8, wherein the plurality of the spacers is disposed near creases of the stacked electrode assembly.

10. The non-aqueous secondary battery in accordance with claim 8, wherein the spirally-wound electrode assembly has a flat shape, with end surfaces thereof perpendicular to the winding axis being oblong, and the plurality of the spacers is disposed at bent portions of the spirally-wound electrode assembly.

11. The non-aqueous secondary battery in accordance with claim 1, wherein the spacer is disposed on a surface of the porous insulating layer, so as to contact only one surface of the positive electrode plate or of the negative electrode plate.

12. The non-aqueous secondary battery in accordance with claim 1, wherein the spacer is disposed on a surface of the porous insulating layer, so as to contact both surfaces of the positive electrode plate or of the negative electrode plate.

13. The non-aqueous secondary battery in accordance with claim 1, wherein the spacer comprises a composite of the resin and fiber.

14. An electrode assembly for a non-aqueous secondary battery comprising:
a positive electrode plate including a positive electrode current collector in long strip form, and a positive electrode active material layer adhering to a surface of the positive electrode current collector;
a negative electrode plate including a negative electrode current collector in long strip form, and a negative electrode active material layer adhering to a surface of the negative electrode current collector;
a porous insulating layer interposed between the positive electrode plate and the negative electrode plate; and
a spacer in film form interposed at least between the positive electrode plate and the porous insulating layer or between the negative electrode plate and the porous insulating layer, the spacer comprising a resin having a solubility such that at 25° C., 3 g or more thereof dissolve in 100 g of a mixed solvent in which the weight ratio of ethylene carbonate, ethyl methyl carbonate, and diethyl carbonate is 20:30:50.

15. A non-aqueous secondary battery comprising:
a positive electrode plate including a positive electrode current collector in strip form, and a positive electrode active material layer adhering to a surface of the positive electrode current collector;
a negative electrode plate including a negative electrode current collector in strip form, and a negative electrode active material layer adhering to a surface of the negative electrode current collector;
a porous insulating layer interposed between the positive electrode plate and the negative electrode plate; and
a non-aqueous electrolyte, in which a copolymer including a vinylidene fluoride unit, a tetrafluoroethylene unit, and a hexafluoropropylene unit, or low-density polyethylene, is dissolved.
